(19) United States
(12) Patent Application Publication
(10) Pub. No.: US 2015/0362707 A1
(43) Pub. Date: Dec. 17, 2015

(54) Optics with Built-In Anti-Reflective Sub-Wavelength Structures

(71) Applicants: Jasbinder S. Sanghera, Ashburn, VA (US); Daniel J. Gibson, Cheverly, MD (US); Catalin M. Florea, Washington, DC (US); Shyam S. Bayya, Ashburn, VA (US); Ishwar D. Aggarwal, Charlotte, NC (US)

(72) Inventors: Jasbinder S. Sanghera, Ashburn, VA (US); Daniel J. Gibson, Cheverly, MD (US); Catalin M. Florea, Washington, DC (US); Shyam S. Bayya, Ashburn, VA (US); Ishwar D. Aggarwal, Charlotte, NC (US)

(73) Assignee: The Government of the United States of America, as represented by the Secretary of the Navy, Washington, DC (US)

(21) Appl. No.: 14/301,491

(22) Filed: Jun. 11, 2014

(51) Int. Cl. G02B 13/14; G02B 3/00; G02B 1/118

(52) U.S. Cl. CPC G02B 13/146; G02B 1/118; G02B 3/0087

(57) ABSTRACT

Optical elements having an intrinsic anti-reflective sub-wavelength structure (SWS) built into one or more surfaces thereof so that the structure becomes integral part of the surface of the lens. The SWS is in the form of a structure of identical or similar objects such as straight or graded cones, pillars, pyramids, or other shapes or depressions, where the dimensions of the objects and the distances between them are smaller than the wavelength of light with which they are designed to interact. The SWS can be a periodic or random, and can be the same across the entire surface or can vary across the surface so as to correspond with the index of refraction of the lens at that point.

### TECHNICAL FIELD

The present invention relates to optics and optical components, specifically optics operating in the near-infrared or the infrared range where such optical components control the geometrical extent of a given wave through their shape, their internal index variation, or a combination of the two.

### BACKGROUND

Components in an optical system, often referred to simply as “optics,” have long been tuned to achieve desired characteristics of an optical beam.

For example, it is often desirable to tune the optics in a system to control the diameter of the beam as it travels from one point to another. One way this has been accomplished has been through the use of a standard bi-convex lens which changes the diameter of a light beam as the beam passes through it, more precisely bringing the beam to a focus point, where the diameter of the light beam has been reduced to a minimum. As light passes through the lens, however, it will experience a certain amount of reflection at the front and at the back of the lens, due to the fact that the lens is made of a material, e.g., glass, which has a different refractive index than the surrounding medium. One common case is that of a laser beam propagating through the air, which has a refractive index of 1, and then through a silica-based glass lens, which has a refractive index greater than 1. The index of refraction of the lens affects not only the direction of the light as it travels through the lens, but affects the extent to which the light is transmitted or experiences loss.

The loss through reflection at an interface is observed without regard to the shape or curvature of the interface. Curved surfaces will reflect light in many directions, based on the wavelength of light, which can be easily put in evidence by the glint noticed from someone's binoculars or from a car's curved windshield for example. In general, a curved (or lensed) surface is characterized by a radius of curvature. The radius of curvature can be either positive, yielding a convex surface, like a bump, or negative, yielding a concave surface, like a depression, while the radius of curvature of a flat surface is infinite.

A gradient index (GRIN) lens is a particular class of optical lenses in which a change in the lens' index of refraction is imposed within the lens body so that manipulation of the light beam is achieved through the way in which the index of refraction changes inside the bulk of the lens rather than through the shapes of the lens surfaces, although the surfaces may still impart some refraction. This is convenient when trying to minimize spherical aberrations or to manipulate optical element's performance across a wide wavelength range.

Thus, in the case of a silica glass bi-convex lens, some of the light is reflected from the first surface as it enters the lens, and some is reflected from the second surface back into the lens. These reflections result in a loss, often called a “Fresnel loss,” of the light as it travels through the through the lens, in this case, a 4% transmission loss as the light enters the lens and another 4% loss as it exits. For example, optical components used in infrared optical systems, which use materials having higher indices of refraction, exhibit even higher losses, with losses of 30% or more at the air-material interface being seen.

Typically the Fresnel losses are reduced by applying a traditional anti-reflective coating (ARC), i.e., multilayer films, on the surfaces. See P. van de Werf and J. Haisma, “Broadband antireflective coatings for fiber-communication optics,” Appl. Opt. 23, 499 (1984). While this is an established technology it has significant drawbacks in the infrared such as operation in narrow wavelength range and over a small angle of incidence range, which limits the numerical aperture of the optic, a very important aspect for a lens. Additionally, the environmental sensitivity and low laser damage thresholds are also of concern. In the case of curved optics the ARC approach yields good results but with all of the drawbacks mentioned above.

Anti-reflective sub-wavelength structures (SWS) on the surface of the lens provide an alternative to such anti-reflective coatings. An alternative to such anti-reflective coatings is the use of an anti-reflective sub-wavelength structure (SWS) on the surface of the optic by which the refractive index can be made to vary gradually from the air value to the value of the lens body. These anti-reflective surface structures are generally periodic in nature such as to generate strong diffraction or interference effects, and can consist in a collection of identical or similar objects such as straight or graded cones, pillars, pyramids and other shapes or depressions with distances between the objects and the dimensions of the objects themselves smaller than the wavelength of light with which they are designed to interact. See J. J. Cowan, “Aztec surface-relief volume diffractive structure”, J. Opt. Soc. Am. 7, 1529 (1990).

The SWS approach can solve all the issues mentioned for the ARC. It has been shown that SWS perform excellently over broad angles (large numerical aperture), see W. H. E. Lowdermilk, D. Milam, “Graded-index antireflection surface for high-power laser applications”, Appl. Phys. Lett. 36, 891 (1980), and it has been demonstrated that the SWS are rather robust and provide high laser damage threshold as well. See D. Hobbs, “Study of the Environmental and Optical Durability of AR Microstructures in Sapphire, ALON, and Diamond”, SPIE 7302, 73020J (2009); see also C. Florea, J. Sanghera, L. Busse, B. Shaw, I. Aggarwal, “Improved Laser Damage Threshold for Chalcogenide Glasses Through Surface Microstructuring.”, SPIE Proc. 7946, 794610 (2011).

In the particular case of infrared optics, the usage of anti-reflective sub-wavelength structures has been very limited while its use on curved optics has not been considered before. This is due to the fact that for high performance, anti-reflective surfaces in infrared, the SWSs need to have features with larger depths (due to the longer infrared wavelengths). For example, for applications in the visible range (wavelengths in the 0.45-0.70 microns range) feature depth of about 0.200 microns is sufficient, while in the mid- to far-infrared range, for example in the 1-15 micron range, the depth of the features has to be around 1 micron and more. Meanwhile, one is also trying not to exceed a certain maximum separation between the individual features (to avoid significant diffraction effects). This makes for a collection of surface features of certain shape and aspect ratio which are not easily obtained.

To date there have been just a few instances of microstructuring curved surfaces and only in the visible region of light.

For example, U.S. Pat. No. 7,545,583 (2009) “Optical Lens Having Antireflective Structure” discusses lenses made out of resin for use in the DVD player pick-up optical assemblies. In the lens described in the '583 patent, however, the SWS is applied to the lens surface rather than built directly into the surface. Furthermore, it is intended for operation at a single wavelength (in particular 0.4 microns).

Another patent, U.S. Pat. No. 7,595,515 (2009) “Method of Making Light Emitting Device Having a Molded Encapsulant,” presents the idea of molding a lensed surface out of a silicon-based resin with an SWS pattern on the surface for use again in the visible light wavelength range.

An even more recent patent, U.S. Pat. No. 8,133,538 (2012) “Method of producing mold having uneven structure” presents the method to produce a metal mold with a SWS on its surface and the process of using said mold to form polymer lenses for use at wavelengths smaller than 0.780 microns.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

The present invention provides optical elements having an intrinsic anti-reflective sub-wavelength structure (SWS) built into one or more surfaces thereof so that the structure becomes integral part of the surface of the lens.

Materials that can be used for lenses having an intrinsic SWS built thereinto in accordance with the present invention include infrared glasses such as chalcogenide and fluoride glasses; ceramics such as ALON®, spinel, CaLa₂S₄ (CLS), ZnS, and ZnSe; and crystals such as silicon, sapphire, and Ge.

Such lenses having an intrinsic anti-reflective SWS built thereinto in accordance with the present invention can be configured to transmit desired wavelengths of light in a controlled manner.

An anti-reflective SWS built into the surface of a lens in accordance with the present invention typically is in the form of a structure of identical or similar objects such as straight or graded cones, pillars, pyramids, or other shapes or depressions, where the dimensions of the objects and the distances between them are smaller than the wavelength of light with which they are designed to interact. In some embodiments, the SWS is in the form of a periodic pattern, such as a “motheye” structure of repeating conical forms or some other ordered structure, while in other embodiments, it is in the form of a random pattern.

An intrinsic SWS built into the surface of a lens in accordance with the present invention can be built into the entire surface or a portion of it, and can be the same across the entire surface or can vary across the surface so as to correspond with the index of refraction of the lens at that point. Such an SWS can be formed by patterning all or part of the surface of the lens to provide the desired structure, for example, by means of a hot-pressing technique which presses the desired SWS into the surface of the lens or by means of an etching technique whereby the desired SWS is etched out of the surface of the lens.

In some embodiments, an SWS in accordance with the present invention can be built into the surface of a lens made from a single material, where the material has a homogeneous refractive index throughout the entirety of the lens. The SWS in such embodiments may be present on one or both surfaces and can be in the form of periodic structure, a random structure, or a combination thereof (e.g. periodic on one surface and random on the other surface). Such a lens having an intrinsic SWS built thereinto in accordance with the present invention can be configured to transmit light having a desired wavelength in the infrared range in a controlled, desired manner.

In other embodiments, the SWS in accordance with the present invention can be built into the surface of a lens having a varying, or graded, index of refraction. The internal change in refractive index may be a continuously varying change, which we call a “continuous GRIN”, but is more commonly known in the art as “GRIN”. The internal change in refractive index may also be discontinuous or discrete and accomplished through the use of layers or shells within the lens, which we call a “step-wise GRIN”. In this invention we use the terms “GRIN” and “graded index” to encompass both a continuously varying and a step-wise-varying graded index of refraction.

A GRIN lens having an intrinsic SWS built thereinto in accordance with the present invention can be configured to transmit light having a desired wavelength, not limited to the infrared, in a controlled, desired manner.

In some embodiments, an SWS in accordance with the present invention can be built into a surface of a composite GRIN lens comprising more than one laminated lens elements having different indices of refraction such that the index of refraction of the lens experiences a sharp change at the interface between elements. In such embodiments, the SWS can comprise a plurality of discrete sections of periodic or random structures wherein the structure configuration (i.e., feature height, width, spacing, and/or profile shape) can be uniform across the surface or where the structure of each discrete section is different so as to correspond to the refractive index of the material into which it is built.

In other embodiments, an SWS in accordance with the present invention can be built into a surface of a GRIN lens comprising a blend of any of the aforementioned materials where the ratio of the constituent materials is controlled such that the index of refraction of the lens varies continuously from one point in the lens to another in a desired manner. In such embodiments, the SWS can comprise a continuous plurality of periodic or random structures wherein the structure configuration (i.e., feature height, width, spacing, and/or profile shape) can be uniform across the surface or can vary continuously to correspond to the refractive index of the material into which it is built.

### BRIEF DESCRIPTION OF THE DRAWINGS

FIGS. 1A-1C illustrate various configurations of anti-reflective sub-wavelength structures that can be built into the surface of a lens in accordance with the present invention.

FIGS. 2A-2C are block diagrams illustrating various embodiments of a homogeneous lens having an intrinsic SWS built into a surface thereof in accordance with the present invention.

FIGS. 3A-3D are block diagrams illustrating various embodiments of a GRIN lens with an internal coarse or step-wise varying refractive index and having an intrinsic SWS built into a surface thereof in accordance with the present invention.

FIGS. 4A-4D are block diagrams illustrating various embodiments of a GRIN lens with an internal fine or continuously varying refractive index and having an intrinsic SWS built into a surface thereof in accordance with the present invention.

FIGS. 5A-5B illustrate aspects of an exemplary periodic “motheye” anti-reflective SWS (FIG. 5A) formed on the surfaces of a thin As₂S₃ lens and the effects of such a structure on the transmission of infrared radiation therethrough (FIG. 5B).

FIGS. 6A-6B illustrate aspects of another exemplary periodic “motheye” anti-reflective SWS (FIG. 5A) formed on the surfaces of a CaLa₂S₄ lens and the effects of such a structure on the transmission of infrared radiation therethrough (FIG. 5B).

FIG. 7 is a plot illustrating the transmission enhancement resulting from fabrication of an anti-reflective SWS on a two-layer GRIN lens in accordance with one or more aspects of the present invention.

FIG. 8 is a photograph depicting fused silica lenses which have and have not been treated by formation of an anti-reflective SWS in accordance with the present invention thereon.

### DETAILED DESCRIPTION

The aspects and features of the present invention summarized above can be embodied in various forms. The following description shows, by way of illustration, combinations, and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

The present invention provides optical lenses having an intrinsic anti-reflective sub-wavelength structure (SWS) built into one or more surfaces thereof.

Lenses having an intrinsic anti-reflective SWS in accordance with the present invention include single-element, homogeneous lenses configured to transmit in the infrared region at wavelengths between 1 and 15 microns and graded-index (GRIN) lenses configured to transmit at any wavelength of interest. As described in more detail below, such lenses can be configured to transmit desired wavelengths of light in a controlled manner.

Materials that can be used for lenses having an anti-reflective sub-wavelength structure fabricated thereon in accordance with the present invention include infrared glasses such as chalcogenide and fluoride glasses; ceramics such as ALON®, spinel, CaLa₂S₄ (CLS), ZnS, and ZnSe; and crystals such as silicon, sapphire, and Ge.

An intrinsic SWS built into a surface of a lens in accordance with the present invention can be in the form of a structure of identical or similar objects such as a structure of straight or graded cones, pillars, pyramids, or other shapes or depressions formed into the surface of the lens as an intrinsic part thereof, where the dimensions of the objects and the distances between them are smaller than the wavelength of light with which they are designed to interact.

As described in more detail below, such an intrinsic SWS can be built into the entire surface or a portion of it, can be the same across the entire surface, or can vary (e.g. in height, depth, spacing or geometric shape) across the surface so as to correspond with the index of refraction of the lens at that point.

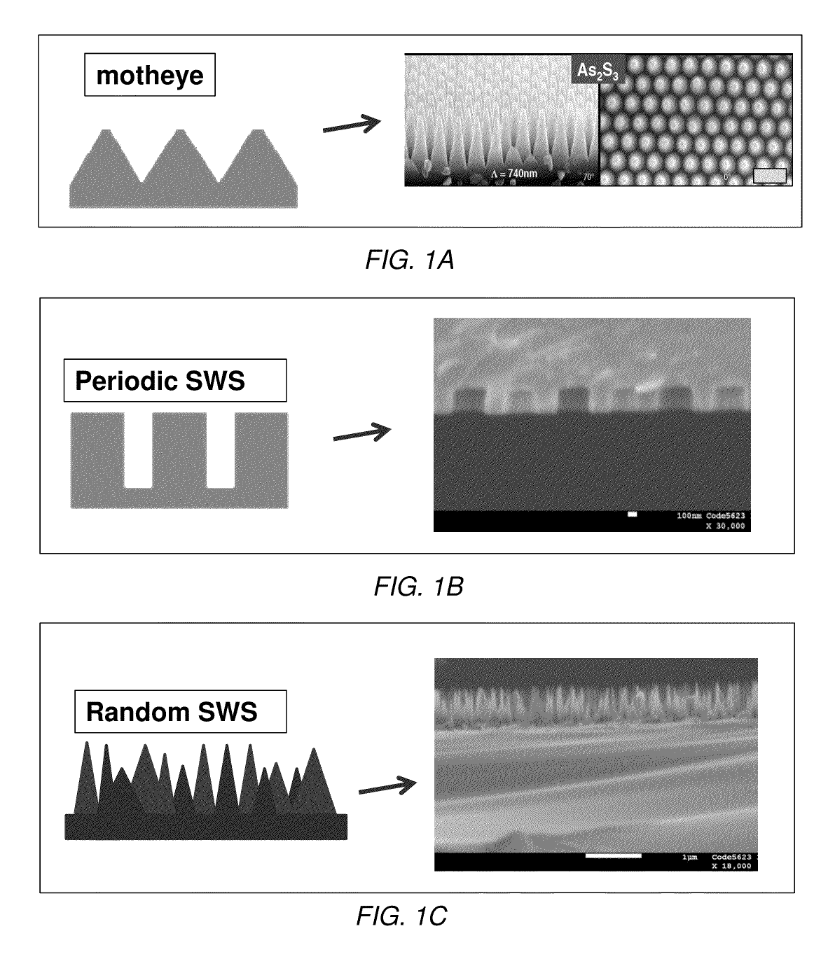

FIGS. 1A-1C illustrate various configurations of the structures that can form an intrinsic SWS built into the surface of a lens in accordance with the present invention. In some embodiments, the SWS is in the form of a periodic pattern such as a “motheye” structure shown in FIG. 1A, while in some embodiments, it can be in the form of some other ordered structure such as the periodic pillar structure shown in FIG. 1B. In still other embodiments, as illustrated in FIG. 1C, the SWS can be in the form of a random pattern of structures formed on a surface of the lens.

Such an SWS can be built into the surface of a lens by patterning all or part of the surface of the lens to provide the desired structure, for example, by means of a hot-pressing technique which presses the desired SWS into the surface of the lens or by means of an etching technique whereby the desired SWS is etched out of the surface of the lens.

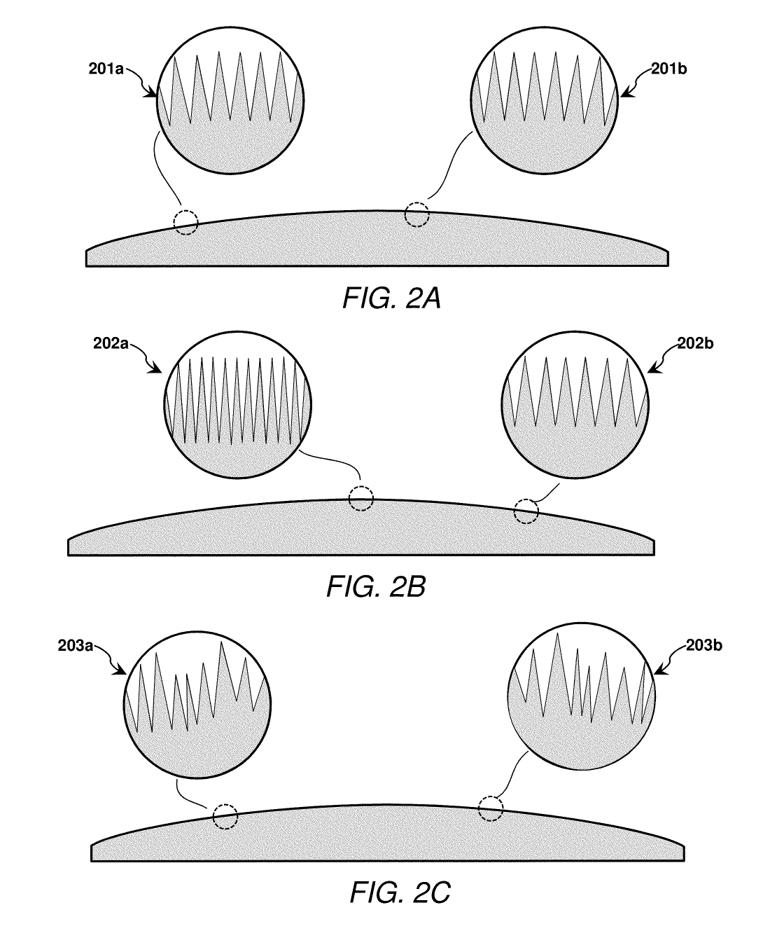

FIGS. 2A-2C, 3A-3D, and 4A-4D illustrate aspects of various embodiments of an optical element having an intrinsic SWS built into the surface thereof in accordance with the present invention, where the insets 201a/201b, etc. in the FIGURES depict a zoomed-in view of the SWS on the lens illustrated therein.

As noted above, an intrinsic SWS can be built into the surface of a homogeneous lens made from a single material having a uniform index of refraction throughout the lens.

FIGS. 2A-2C are block diagrams illustrating various exemplary configurations of such a single element, homogeneous lens having an intrinsic SWS built into the surface thereof. Thus, as shown in the FIG. 2A, in accordance with the present invention, such a lens can have a periodic SWS fabricated thereon where the period of the SWS is uniform over the surface of the lens, as illustrated by insets 201a and 201b, or where the period varies, as illustrated by insets 202a/202b in FIG. 2B. In other embodiments, the SWS can comprise a random set of structures formed on the surface of the lens, as illustrated in insets 203a and 203b in FIG. 2C. The shapes of the structures in such a periodic or random SWS can be the same, e.g., all cones or all pillars, or can have various shapes, and in the case of the random structure, can have varying heights, widths, and separations therebetween.

The size of the features in the SWS and their spacing can be tailored to the lens material and the wavelength of interest so that the thus-fabricated lens having the intrinsic SWS thereon is configured to transmit infrared radiation (i.e., radiation having wavelengths between 1 and 15 microns) in a controlled, desired manner.

In other embodiments, the SWS in accordance with the present invention can be built into the surface of a lens having a varying, or graded, index of refraction. The internal change in refractive index may be a continuously varying change, which we call a “continuous GRIN”, but is more commonly known in the art as “GRIN”. The internal change in refractive index may also be discontinuous or discrete and accomplished through the use of layers or shells within the lens, which we call a “step-wise GRIN”. In this invention we use the terms “GRIN” and “graded index” to encompass both a continuously varying and a step-wise-varying graded index of refraction.

In the case of GRIN lenses, the size of the features in the SWS and their spacing can be tailored to the lens material and the wavelength of interest so that the thus-fabricated lens having the intrinsic SWS thereon is configured to transmit radiation having a desired wavelength or range of wavelengths (including but not limited to infrared radiation having wavelengths between 1 and 15 microns) in a controlled, desired manner.

In some embodiments, an intrinsic SWS in accordance with the present invention can be built into the GRIN lens by patterning its surface after its fabrication, e.g., by hot-pressing, indenting or etching an existing lens, while in other embodiments, the surface of the lens can be patterned with the SWS during lens formation, e.g., by imprinting the surface of the lens during a hot press which joins the lens components together or imparts a desired curvature to the lens.

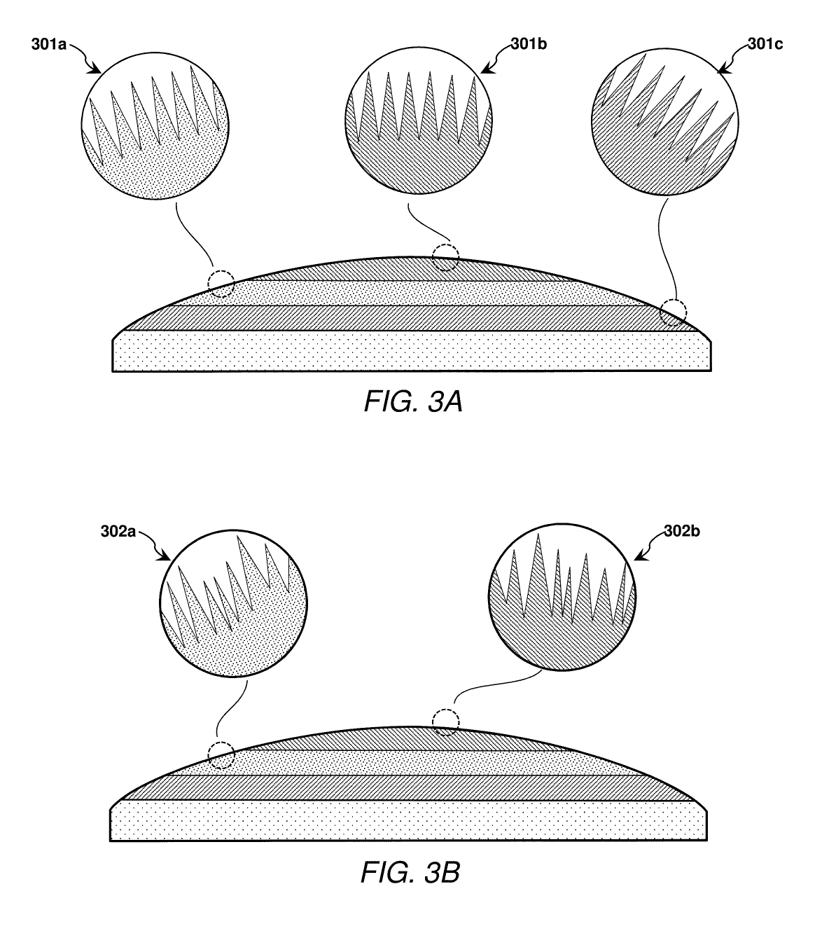

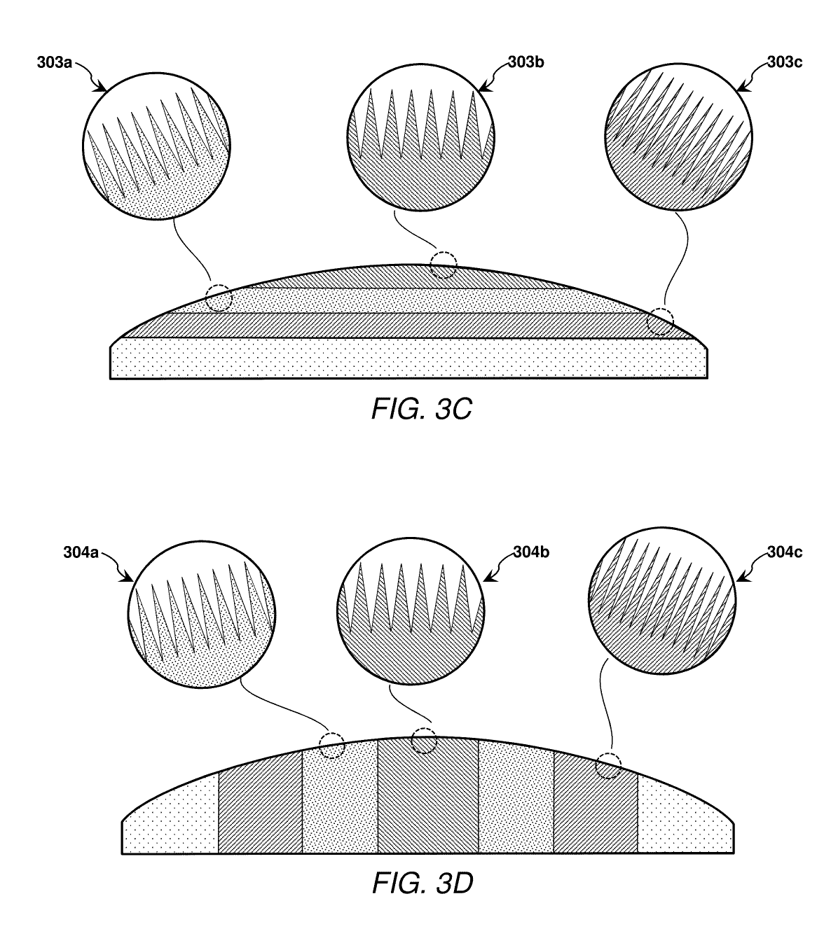

FIGS. 3A-3D are block diagrams illustrating various exemplary configurations of a step-wise gradient GRIN lens having an intrinsic SWS built into the surface thereof in accordance with the present invention. In such embodiments, the SWS can be in the form of a plurality of discrete sections, each having a periodic or random arrangement of structural elements, where the arrangement of structural elements in each SWS section is configured to correspond to the index of refraction of the lens at that point on the surface.

Such step-wise gradient GRIN lenses are fabricated from more than one discrete material layers laminated together, where each material has a corresponding index of refraction. Materials that can be used for a GRIN lens can include silicate, chalcogenide, or fluoride glasses, ceramics, and crystals. Different types of materials can be used for the different layers, so long as the thermal expansion coefficients are reasonably matched such that any residual stresses from manufacture are not sufficient to cause mechanical failure (e.g. cracking, delamination, deformation) and the refractive index variation between the materials matches the desired lens design.

Methods for fabricating such a step-wise GRIN lens are described in U.S. Patent Application Publication No. 2012/0206796 and U.S. Provisional Patent Application No. 61/787,365 filed on Mar. 15, 2013, each of which has several inventors in common with the present application, and which are hereby incorporated into the present disclosure in their entirety.

In some cases, the index of refraction can vary along the axis of the lens, with the layers extending through the entire lateral width of the lens, as shown in FIGS. 3A-3C, or in only a part of the lens structure, e.g., in a central portion of the lens. In some such cases said layers may be substantially flat as shown in FIGS. 3A-3C, while in other such cases said layers may be curved. In other cases, such as that illustrated in FIG. 3D, the layers are arranged as concentric shells such that the index of refraction is constant along the lens axis but varies a different distances from the axis (i.e., radially). In some such cases said layers or shells may be substantially cylindrical, as shown in FIG. 3D, while in other such cases said layers may be conical or another shape. As noted above, an intrinsic SWS built into a surface of such step-wise gradient GRIN lenses can be in the form of a plurality of discrete sections. In some embodiments, the form of all of the sections can be the same so that the SWS has a uniform periodic or random structure over the entire surface of the lens, while in other embodiments, the SWS can have different periodic structures over different parts of the surface, or can have a combination of structures, for example, can be periodic over a first portion of the lens surface and be random other another portion, with the characteristics of the elements of the structure, i.e., their height, depth, spacing or geometric shape being configured to correspond with the index of refraction of the lens at that point.

In some embodiments, a step-wise GRIN lens can have an axial refractive index profile, whereby the refractive index varies only in the direction of the lens axis, with the GRIN being exposed at a curved surface of the lens. In accordance with the present invention, in some embodiments, an intrinsic SWS built into a step-wise GRIN lens with an axial refractive index profile and one or more curved surfaces can have a uniform periodic structure such as that shown in insets 301a and 301b shown in FIG. 3A, or can have a random structure such as that shown in insets 302a and 302b in FIG. 3B. In other embodiments, the SWS can be a non-uniform structure comprising a plurality of discrete sections of structures such as those shown in insets 303a/303b/303c in FIG. 3C, with the configuration (i.e., feature height, width, spacing and profile shape) of the elements of the structures in each discrete section corresponding to the refractive index of the lens material on which they are built.

In other embodiments, as illustrated in FIG. 3D, a step-wise GRIN lens can have a radial refractive index profile, whereby the refractive index is constant along the lens axis and varies with radial distance from the lens central axis, with the GRIN being exposed by a curved surface of the lens. In some embodiments in accordance with the present invention, an SWS built into the surface of a step-wise GRIN lens having a radial refractive index profile can have a uniform periodic or random structure over the entire surface of the lens. In other embodiments, such as that illustrated in FIG. 3D, the SWS can have a non-uniform structure comprising a plurality of discrete sections such as those shown in insets 304a, 304b, and 304c, with the configuration (i.e., feature height, width, spacing, and/or profile shape) of the elements of the structures in each discrete section corresponding to the refractive index of the lens material on which they are built.

In some cases, a step-wise GRIN lens can have a spherical gradient, wherein the refractive index varies with distance from a point on the lens axis, which may be inside or outside the lens, where a curved surface of the lens may or may not expose the GRIN. In accordance with the present invention, a step-wise GRIN lens with a spherical refractive index profile and one or more curved surfaces can have a uniform or non-uniform intrinsic SWS comprising a plurality of structures, with the configuration (i.e., feature height, width, spacing, and/or profile shape) of the structures corresponding to the refractive index of the lens material on which they are built.

In other cases, the refractive index of a GRIN lens does not change in discrete steps but, rather, varies continuously throughout the lens.

Such GRIN lenses having a continuously varying refractive index can be fabricated by diffusing chemical elements (i.e., dopants) into a homogeneous lens material, thereby imparting gradients in chemical composition and refractive index. Materials that can be used for a continuously varying GRIN lens can include silica, chalcogenide, or fluoride glasses, ceramics, and crystals and should accept dopants and permit the diffusion of dopants. Such continuously varying GRIN lenses can also be fabricated by first fabricating a step-wise gradient lens and second heating said lens to a prescribed temperature for a prescribed time to encourage diffusion of the chemical elements between the constituent materials in the lens thereby imparting gradients in chemical composition and refractive index in the lens. Such gradients can be axial, radial, or spherical.

Methods for fabricating such a continuously varying gradient GRIN lens are described in U.S. Patent Application Publication No. 2012/0206796, supra, and U.S. Provisional Patent Application No. 61/787,473, supra.

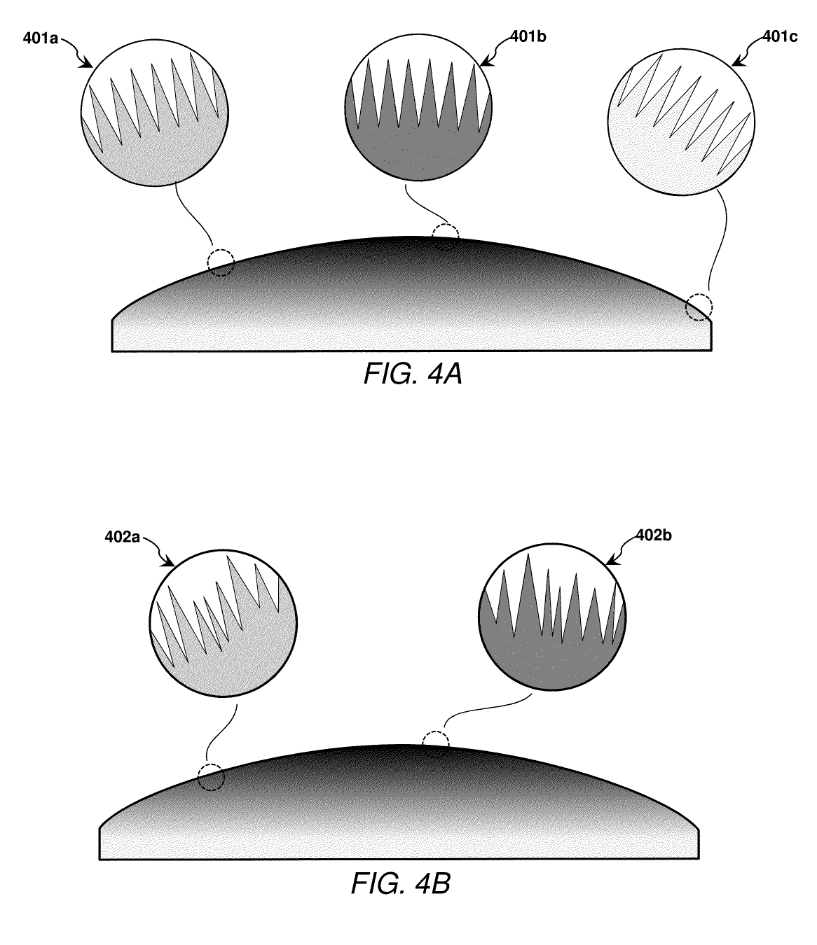

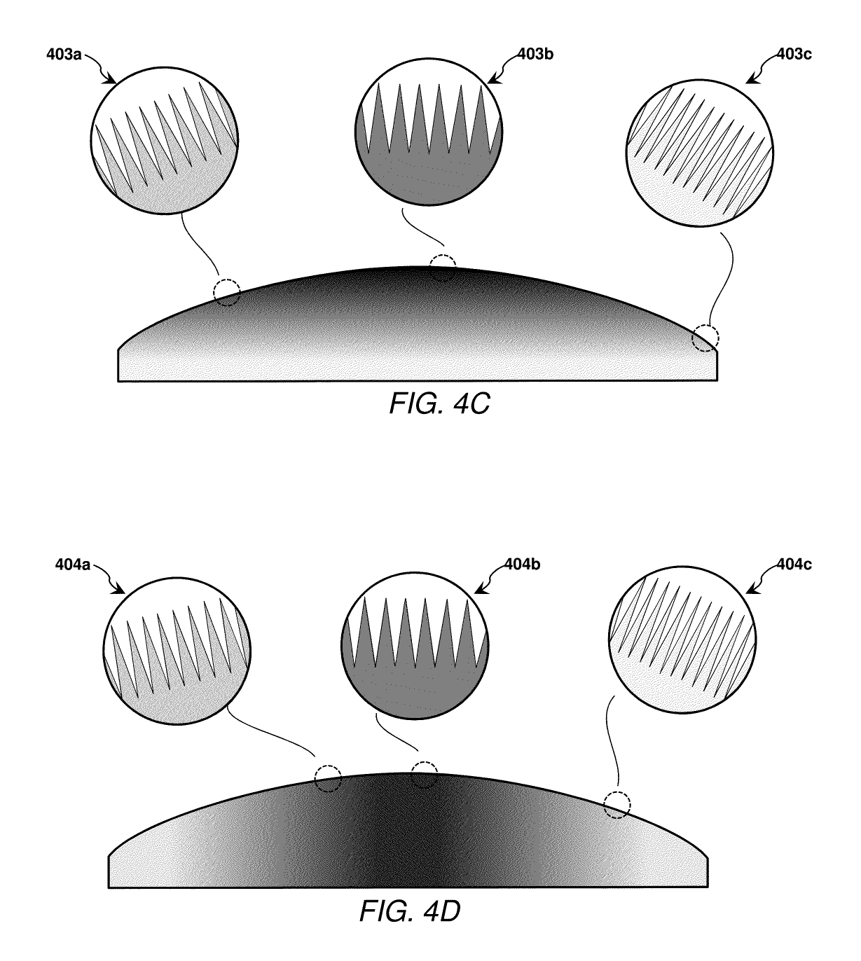

FIGS. 4A-4D are block diagrams illustrating various exemplary embodiments of an intrinsic SWS built into the surface of a GRIN lens having a continuously varying refractive index in accordance with the present invention. An intrinsic SWS built into the surface of a continuously varying gradient GRIN lens in accordance with the present invention can comprise a plurality of periodic or random structures wherein the structure configuration (i.e., feature height, width, spacing, and/or profile shape) can be uniform across the surface or can vary continuously to correspond to the refractive index of the material into which it is built.

Thus, in a first exemplary embodiment, illustrated in FIG. 4A, a continuously varying gradient GRIN lens can have an uniform periodic intrinsic SWS such as that shown in insets 401a/401b/401c built into a surface thereof. In another embodiment, illustrated in FIG. 4B, an intrinsic SWS built into the surface of a continuously varying gradient GRIN lens can have non-uniform intrinsic SWS such as an SWS comprising a plurality of random structures as shown in insets 402a and 402b.

As illustrated in FIG. 4C, in some embodiments, a continuously varying gradient GRIN lens can have an axial refractive index profile, whereby the refractive index varies only in the direction of the lens axis, with the GRIN being exposed by a curved surface of the lens. In accordance with the present invention, a continuously varying gradient GRIN lens with an axial refractive index profile and one or more curved surfaces can have a non-uniform intrinsic SWS comprising a continuous plurality of periodic structures such as those shown in insets 403a, 403b, and 403c, with the configuration (i.e., feature height, width, spacing, and/or profile shape) of the structures varying smoothly along the surface in a manner such that the configuration of the structure at any point on the lens surface corresponds to the refractive index of the lens at that point.

In other embodiments, such as the embodiment illustrated in FIG. 4D, a continuously varying gradient GRIN lens can have a radial refractive index profile, whereby the refractive index is constant along the lens axis and varies with radial distance from the lens axis, with the GRIN being exposed by a curved surface of the lens. In accordance with the present invention, a continuously varying gradient GRIN lens with a radial refractive index profile and one or more curved surfaces can have a non-uniform intrinsic SWS comprising a continuous plurality of structures such as the plurality of periodic structures shown in insets 404a, 404b, and 404c, with the configuration (i.e., feature height, width, spacing, and/or profile shape) of the structures varying smoothly along the surface of the lens in a manner such that the configuration of the structure at any point on the surface corresponds to the refractive index of the lens at that point on the surface.

In still other embodiments, a continuously varying gradient GRIN lens can have a spherical gradient, wherein the refractive index varies with distance from a point on the lens axis, which may be inside or outside the lens, where the curved surface of the lens may or may not expose the GRIN. In accordance with the present invention, a continuously varying gradient GRIN lens with a spherical refractive index profile and one or more curved surfaces can have a non-uniform intrinsic SWS comprising a continuous plurality of structures, with the configuration (i.e., feature height, width, spacing and profile shape) of the structures varying smoothly along the surface in a manner such that the configuration of the structure at any point on the surface corresponds to the refractive index of the lens at that point.

Some specific examples illustrating the improvement in performance of lenses having an intrinsic anti-reflective SWS built into the surface thereof in accordance with the present invention will now be described.

### Example 1

An intrinsic anti-reflective SWS was built into the surface of a single-element chalcogenide optical glass lens consisting of a glass based primarily on AsₓS_{y} or AsₓSe_{y} (with x and y typically but not needed to be x=2 and y=3), on a flat substrate, though in other embodiments, any other suitable glasses for transmission in the in the 1-12 μm region or portions thereof can be used. The substrate can be made out of nickel, silicon, diamond, or any other suitable material.

The lens had a single surface having an intrinsic anti-reflective SWS patterned thereon by means of hot-pressing the pattern into the surface of the lens. As noted above, the dimensions of the objects and the spacing between them were optimized as to enhance the transmission of light through the lens.

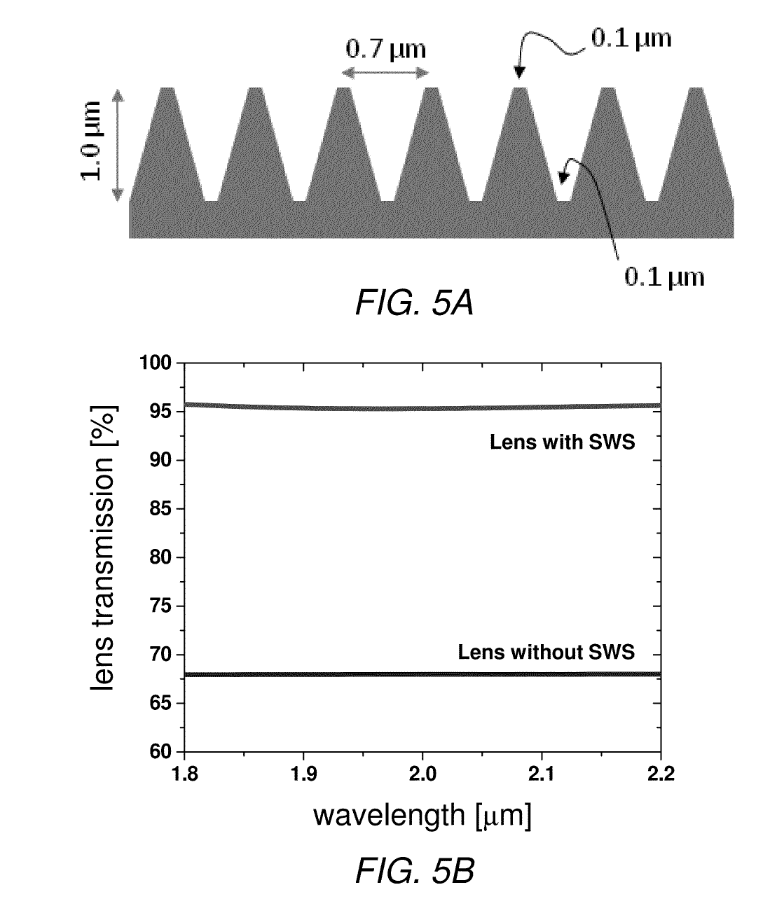

FIG. 5A is a block diagram illustrating aspects of the SWS used in this exemplary case. As illustrated in FIG. 5A, the SWS consisted of a motheye structure, i.e., plurality of semi-conical features, each of which is 1 μm tall as measured from the lens surface and has a flat top surface 0.1 μm wide, where the features are periodically spaced so that the bottom edges of any two features are 0.1 μm apart, and where the features are configured so that the tops when so spaced are 0.7 μm apart.

As illustrated in the plot shown in FIG. 5B, the optical transmission of a thin As₂S₃ lens having such an intrinsic SWS built into a surface thereof is about 95% at an operating wavelength around 2 μm as compared to the 65% optical transmission of a lens which does not have such an SWS on its surface. Thus, as illustrated in FIG. 5B, an optical lens having a sub-wavelength structure fabricated on a curved surface thereof in accordance with the present invention exhibits substantially reduced losses from reflection and substantially improved optical transmission over that exhibited by the same lens without such a structure.

### Example 2

In this Example, a CaLa₂S₄ (CLS) ceramic lens had an intrinsic SWS built into the surface thereof in accordance with the present invention.

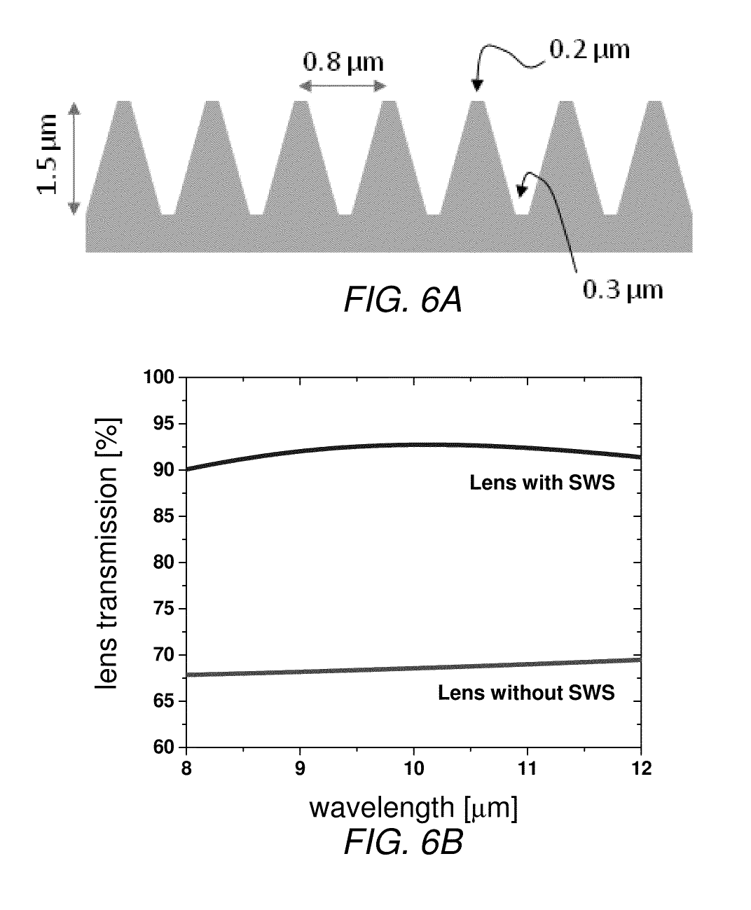

As illustrated in FIG. 6A, the SWS in this case also was in the form of a motheye structure, in this case a structure consisting of a plurality of semi-conical features 1.5 μm tall and 0.2 μm wide, spaced so that the bottom edges of any two features are 0.13 μm apart and the tops are 0.8 μm apart.

As shown in FIG. 6B, the optical transmission of such a lens at wavelengths from 8 to 12 μm increases from about 68% for a lens lacking an intrinsic SWS to about 90-95% for a lens having the intrinsic SWS described above.

Thus, as can be readily seen from the plots in FIGS. 5B and 6B, the presence of the intrinsic SWS built into the surface of a lens in accordance with the present invention greatly increases the transmission of both glass and ceramic lenses, both in the mid-IR (1.8 to 2.2 μm) and in the long-wavelength IR (8 to 12 μm).

### Example 3

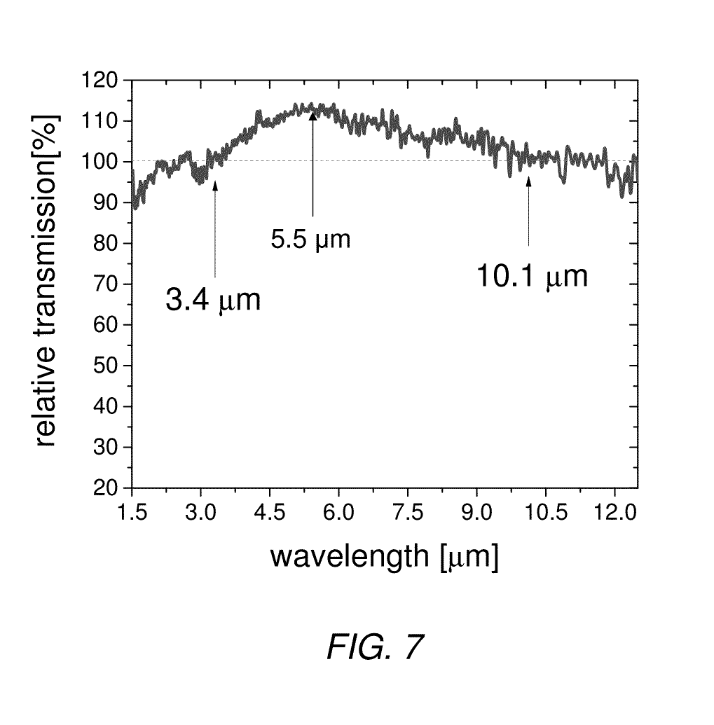

A step-wise GRIN comprising one layer of As—S glass and one layer of As—S—Se glass was prepared in which one of the surfaces had a section with an intrinsic periodic SWS transferred during the pressing stage from the associated vitreous carbon (Vit C) plate. The SWS had a feature spacing of 2.43 μm and the individual features were bumps of about 900 nm height. The transmission through the step-wise GRIN was measured in a region where no patterning had occurred and it was compared with the transmission in the region patterned with the periodic structure. The result of this comparison is shown in the plot in FIG. 7. As can be seen from the plot, the presence of the SWS enhances the transmission of light in the 3-10 μm wavelength range, with the transmission ratio of the two sections of the lens exhibiting a relative improvement of 13% at the 5.5 μm peak. The glass comprising the surface of the step-wise GRIN had a refractive index of 2.46, which means that the facet transmission from increased from 82% to about 93% (that is to say that the reflection loss has been reduced from 18% to about 7%).

### Example 4

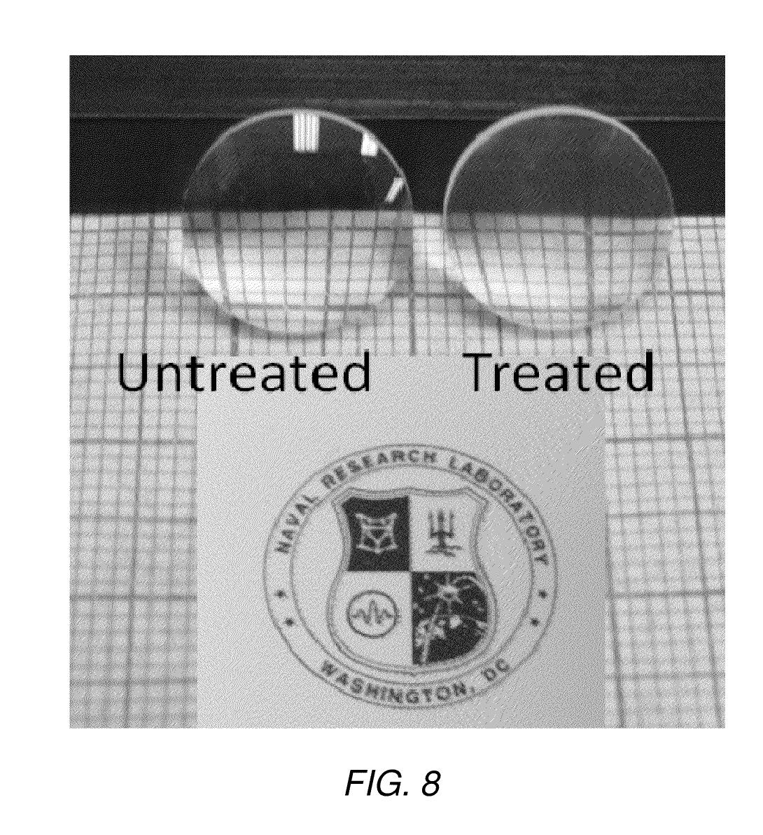

In another example, we consider a homogeneous fused silica lens which has been etched in a C₄F₈, SF₆ and O₂ combination. The ½″ diameter, 30 mm focal length lens has shown an improvement in its curved surface transmission from 96.6% (untreated) to 98.1% (treated) at 1.06 μm. Much better performance, close to 99.9% surface transmission, can be expected based on our results obtained on flat substrates. With the appropriate chemistry and parameters, etching of spinel ceramic lenses and chalcogenide glass lenses is also possible. The silica lens can be easily used in the 1-2.5 μm, and even beyond with proper design of its thickness. As can be seen from the photograph in FIG. 8, the “treated” lens on the right, which has an intrinsic SWS on the surface thereof in accordance with the present invention exhibits significantly less reflection from the surface than does the “untreated” lens shown on the left.

As noted above, an intrinsic SWS can be formed on the surface of a lens in accordance with the present invention by any suitable means, such as by hot-pressing the SWS pattern into lens surface during or after formation of the lens or by etching the SWS pattern into the lens.

The methods include methods of patterning one or more SWS into the surfaces of various optical lenses, including GRIN lenses intended for use in the infrared region covering the 1 micron to 15 microns span. These methods can be used with many different materials which transmit in the infrared, including but not limited to chalcogenide or fluoride glasses; ALON®, spinel, CaLa₂S₄ (CLS), ZnS, and ZnSe ceramics; and silicon, sapphire, or Ge crystals. The SWS can be formed by a variety of molding approaches or certain dry etching treatments and can be used to create an intrinsic SWS built into the surface of an already formed lens or to mold lenses with the intrinsic SWS formed therein in a single step, starting directly from the chemical precursors.

Some exemplary embodiments of these methods will now be described.

### Method 1

In the case of using molds, the process is some form of hot pressing, which is defined as the act of modifying the shape of a single solid object or consolidating distinct yet related entities (such as particles in a spinel powder or several layers of various chalcogenide glasses) into a desired shape through the application of heat and pressure. It can be performed simply in free space (like on a hot plate or on a laser-assisted heating holder) using custom designed molds (made of nickel, diamond or other suitable materials) or in a specialized chamber, in which the materials being consolidated are confined in a die (made of graphite, ceramic, or metals and their alloys or other suitable, non-reactive material). In the latter case, pressure is applied through punches also made of graphite, ceramic or metal/alloys. The die and punch surfaces, contacting the collection of entities, are lined to prevent reactions that may damage the die or unfavorably affect the final shape. Typical lining materials are graphite foil or boron nitride but other materials can be envisioned (silicon carbide, silicon nitride, tungsten carbide, boron nitride, boron carbide, etc.). The lining material is pliable and as pressure is applied during the hot pressing operation, the layer of entities next to the lining material is pressed into the lining material creating a surface that is transferred onto the finished part.

Representative embodiments of this first method are described explicitly in the following.

In one embodiment, an SWS (ordered or random) is built on the flat surface of a robust substrate. The lens on the surface of which the SWS is to be transferred is brought in contact in free space to the heated substrate and, through a series of motions, a significant portion of the lens is stamped with the pattern from the substrate. Should the SWS-carrying substrate have a certain non-infinite radius of curvature, the radius of curvature will have to match the radius of curvature of the lens onto which the SWS is desired to be transferred. The characteristic dimensions (height, taper, spacing, etc. . . . ) of the SWS may be invariant with respect to position on the surface, or in a case where the refractive index of the substrate varies with respect to position on the surface, for example when a the surface reveals a refractive index gradient, the SWS may be carefully designed such that its characteristic dimensions vary across the surface in such a way that the optical transmission is optimized relative to the local refractive index across the surface.

In another embodiment, a modified hot pressing method is used where the pliable lining material is replaced with a structured layer which contains the negative of the SWS (random or ordered) desired to be transferred on the surface of the part. The lining material is separate from the die and punch surfaces so that it is easily replaceable should it become damaged after a certain number of press runs. Ideally, this structured layer is harder than the materials to be pressed.

In the method disclosed here the pressing method is applied to a stack of layers of finite thickness hence the heat schedule, pressure, and time are to be modified such that not only the SWS structure is properly transferred to the top and bottom layers but the interfaces between the intermediate layers is also properly modified. This is important since the index variation from layer to layer and across the layers plays an important optical role.

In yet another embodiment, a modified hot press method is used where the pliable lining material is replaced with a structured material which is hard enough such that it can be an integral part of the punch. The structured surface of the punch then contains the negative of the SWS (random or ordered) desired to be transferred on the surface of the part. Ideally, this structural layer is harder than the materials to be pressed. An example of such a material is represented by tungsten carbide.

In another embodiment, a modified hot press method comprises two or more stages. The first stage is the forming stage and employs an upper mold and a lower mold comprised of a suitable material (e.g. silicon carbide, vitreous carbon, nickel) with appropriate curvature and appreciably smooth surfaces (i.e. without SWS imparting texture). The final stage is the texturing stage and employs an upper mold and a lower mold comprised of a suitable material (e.g. silicon carbide, vitreous carbon, nickel) with appropriate curvature corresponding to that of the final lens and SWS imparting texture. The curvature of the molds in the first forming stage may be the same as the curvature in the final texturing stage, or the curvatures may be different. As described below, such a method may also include one or more intermediate stages to form the lens.

In some embodiments, the starting material is provided in a form that has a very different surface curvature than that of the final lens (e.g. the starting material has two flat surfaces each with infinite curvature and the lens is bi-convex with two different aspheric curvatures or the starting material is spherical with a curvature=1.0 cm and the lens is plano-convex with one surface having infinite curvature and one surface having curvature=1000 cm). In these embodiments, one or more intermediate forming stages may be used after the first forming stage, but before the final texturing stage, such that the first and any intermediate stages each change the surface shape of the material in incremental amounts such that the lens is in final or near-final shape prior to the final texturing stage.

### Method 2

In the case of dry etching, the lens to be treated will typically be placed in a dry etcher, such as an inductively-coupled reactive ion-etching (ICP-RIE) machine and an appropriate combination of gas pressure, gas flow, plasma powers and etch time can be identified for the surface facing the plasma to be modified in a quasi-random manner. The surface such treated is typically characterized by a collection of pillars of the right shape and aspect ratio which will provide the desired antireflective effect (hence the random SWS aspect). A periodic SWS can also be created onto the surface of the lens by transferring through plasma etching a periodic pattern formed initially in a resist layer which has been deposited on the surface of the lens at the beginning of the process.

Representative embodiments of this second method are described explicitly in the following.

In one embodiment, a random SWS is created directly on the surface of a lens using an ICP-RIE machine using chemistry and etch parameters appropriate to the lens substrate used. In another embodiment, an ordered SWS is created on the surface of a lens within a resist layer using lithography or a related process. The pattern is then transferred into the surface of the lens using dry etching.

Advantages and New Features:

The present invention provides a method of producing optical lenses for the near-infrared and infrared region, lenses provided with surfaces which exhibit substantially reduced reflection loss.

According to this method, the reduction in the reflectivity is obtained by structuring directly the lens surfaces either after the lens is obtained or during the process of its making.

The optics obtained through this method can be used in environments were low reflection is required and/or where high laser damage threshold is needed.

The embodiments of this method allow for optics with enhanced performance across a very broad wavelength range and a very broad numerical aperture.

Although particular embodiments, aspects, and features have been described and illustrated, it should be noted that the invention described herein is not limited to only those embodiments, aspects, and features, and it should be readily appreciated that modifications may be made by persons skilled in the art. The present application contemplates any and all modifications within the spirit and scope of the underlying invention described and claimed herein, and all such embodiments are within the scope and spirit of the present disclosure.

1. An optical element comprising a lens having an anti-reflective sub-wavelength structure (SWS) built into a surface thereof such that the SWS forms an intrinsic part of the lens, the SWS comprising a plurality of structural elements wherein at least one of a height, a shape, and a separation of the structural elements of the SWS is configured to cause the lens to transmit light at a desired wavelength in a desired, controlled manner.

2. The optical element according to claim 1, wherein the SWS comprises a periodic arrangement of structural elements.

3. The optical element according to claim 1, wherein the SWS comprises a random arrangement of structural elements.

4. The optical element according to claim 1, wherein an arrangement of structural elements of the SWS is uniform across the surface of the lens.

5. The optical element according to claim 1, wherein an arrangement of structural elements of the SWS is non-uniform across the surface of the lens.

6. The optical element according to claim 1, wherein the structural elements of the SWS include at least one of a plurality of motheye structures, conical structures, and pillar structures.

7. The optical element according to claim 1, wherein the lens is a homogeneous lens, and wherein the SWS is configured to cause the lens to transmit infrared light at a desired wavelength in a controlled manner.

8. The optical element according to claim 1, wherein the lens is a non-homogeneous lens having a graded index of refraction, and wherein the SWS is configured to cause the lens to transmit light at a desired wavelength in a controlled manner.

9. An optical element comprising a lens having step-wise graded index of refraction and having an anti-reflective sub-wavelength structure (SWS) built into a surface thereof such that the SWS forms an intrinsic part of the lens;
wherein the SWS comprises a plurality of discrete sections of structural elements, wherein at least one of a height, a shape, and a separation of the structural elements of the SWS is configured to correspond to an index of refraction of the lens where the section is located; and
wherein the SWS is configured to cause the lens to transmit light at a desired wavelength in a desired, controlled manner.

10. The optical element according to claim 9, wherein the SWS includes at least one discrete section comprising a periodic arrangement of structural elements.

11. The optical element according to claim 9, wherein the SWS includes at least one discrete section comprising a random arrangement of structural elements.

12. The optical element according to claim 9, wherein all of the discrete sections of the SWS have a periodic structure.

13. The optical element according to claim 12, wherein at least one of a height, a shape, and a separation of structural elements in all of the discrete sections of the SWS are the same.

14. The optical element according to claim 12, wherein at least one of a height, a shape, and a separation of structural elements in at least two of the discrete sections of the SWS are different.

15. The optical element according to claim 9, wherein the structural elements of the SWS include at least one of a plurality of motheye structures, conical structures, and pillar structures.

16. An optical element comprising a lens having a continuously graded index of refraction and having an anti-reflective sub-wavelength structure (SWS) built into a surface thereof such that the SWS forms an intrinsic part of the lens;
wherein the SWS comprises a continuous plurality of structural elements, wherein at least one of a height, a shape, and a separation of each of the structural elements of the SWS is configured to correspond to an index of refraction of the lens where the element is located, a configuration of the structural elements varying smoothly across a surface of the lens; and
wherein the SWS is configured to cause the lens to transmit light at a desired wavelength in a desired, controlled manner.

17. The optical element according to claim 16, wherein at least one of a height, a shape, and a separation of structural elements of the SWS is the same over the surface of the lens.

18. The optical element according to claim 16, wherein at least one of a height, a shape, and a separation of structural elements at a first location on the surface of the lens is different from at least one of a height, a shape, and a separation of structural elements at a second location on the surface of the lens.

19. The optical element according to claim 16, wherein the SWS includes a periodic arrangement of structural elements on at least a portion of the lens surface.

20. The optical element according to claim 16, wherein the SWS includes at least one random arrangement of structural elements on at least a portion of the lens surface.

21. The optical element according to claim 16, wherein the structural elements of the SWS include at least one of a plurality of motheye structures, conical structures, and pillar structures.
